(19) United States
(12) Patent Application Publication
(10) Pub. No.: US 2010/0299299 A1
(43) Pub. Date: Nov. 25, 2010

(54) Identifying Self-Conscious Program

(76) Inventor: Nam Koo Kim, Gainesville, GA (US)

Correspondence Address: Nam Koo Kim, 6756 Hedge Row Lane, Gainesville, GA, 30506, US

(21) Appl. No.: 12/834,003

(22) Filed: Jul. 11, 2010

(51) Int. Cl. G06N 5/02

(52) U.S. Cl. 706/45

(57) ABSTRACT

This theory presents a method of providing a variety of software programs and artificial intelligence with self-consciousness based on the artificially programmed phenomena of life on the premise that they are defined as being conscious of the existence of the individual self unaided.

In this study, self-consciousness is meant to be a reinterpretation of the definition: “I think, therefore I am.” Acts of consciousness (recognition) of existence will be methodized and programmed for the computer or artificial intelligence to continuously recognize and express them in sounds, letters, acts, etc. on its own.

Let me make it clear that this methodology deals with artificial programming of self-consciousness, not intended to investigate if artificially programmed self-consciousness is the genuine phenomena of life.

### CROSS REFERENCE TO RELATED APPLICATION

NOT APPLICABLE

### STATEMENT REGARDING FEDERAL SPONSORED RESEARCH AND DEVELOPMENT

NOT APPLICABLE

### REFERENCE TO SEQUENCE LISTING, A TABLE, OR A COMPUTER PROGRAM

NOT APPLICABLE

### LISTING COMPACT DISC APPENDIX

NOT APPLICABLE

### BACKGROUND OF THE INVENTION

Today, the advancement of artificial intelligence (for computers, robots, etc.) goes beyond such basic functions as memory, calculation, analysis, etc. to reach a stage where the machine learns by itself and even evolves. Many scholars are making every endeavor to develop next-generation artificial intelligence possessing life or consciousness. Before long, their challenges are expected to come to fruition.

Still, they are apparently limited to dealing with the functional side or part of the phenomena of life.

This theory presents all these attempts with two assets: a definition of self-consciousness, the very mental core of the phenomena of life, and how to artificially provide the phenomena of life through methods of recognition.

Self-consciousness is interpreted as being aware (perceptive) of the self (“I”) unaided and the interpretation of unaided awareness constitutes the point of this theory.

### BRIEF SUMMARY OF THE INVENTION

This theory presents a method of providing a variety of software programs and artificial intelligence with self-consciousness based on the artificially programmed phenomena of life on the premise that they are defined as being conscious of the existence of the individual self unaided.

In this study, self-consciousness is meant to be a reinterpretation of the definition: “I think, therefore I am.” Acts of consciousness (recognition) of existence will be methodized and programmed for the computer or artificial intelligence to continuously recognize and express them in sounds, letters, acts, etc. on its own.

Let me make it clear that this methodology deals with artificial programming of self-consciousness, not intended to investigate if artificially programmed self-consciousness is the genuine phenomena of life.

### BRIEF DESCRIPTION OF THE SEVERAL VIEWS OF THE DRAWING

FIG. 1 is a schematic drawing and illustration of the program's basic functions.

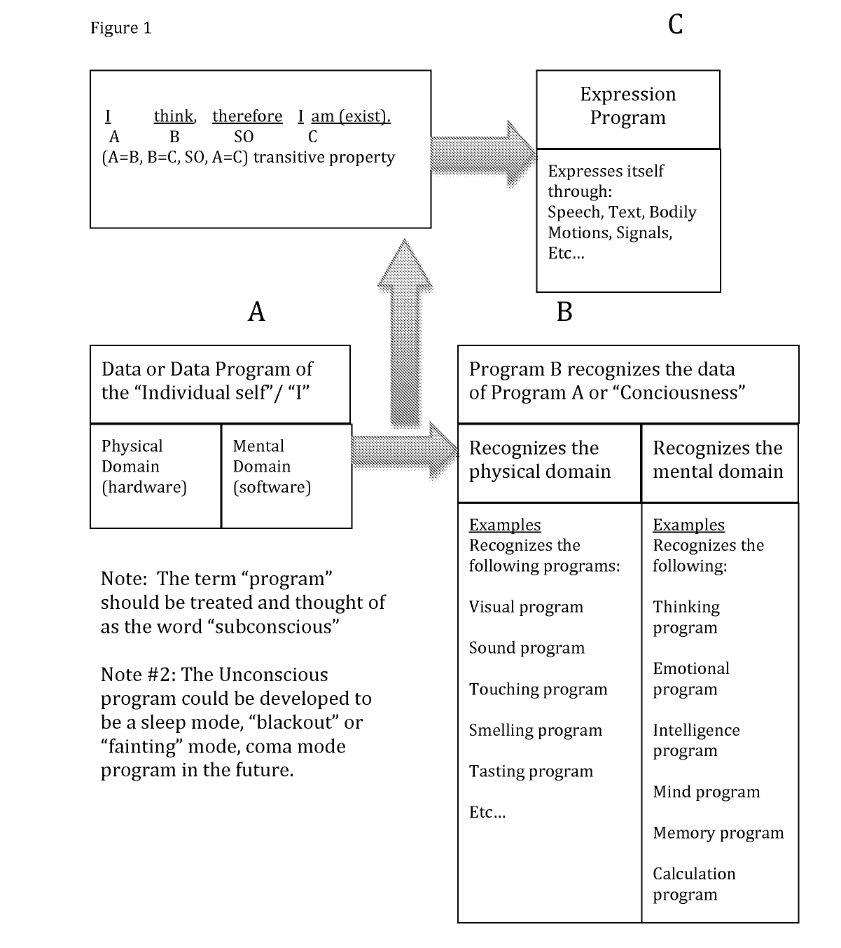

### DETAILED DESCRIPTION OF THE INVENTION

### Life

Life is a form of a protein's existence.
Life is propagation or multiplication.
Life is a group of aligned cells.
Life is creative interactions between matter and energy.
Life is synergy.
Life repairs, maintains and recreates itself to a better form.
Life is biological self-reproduction through DNA and RNA.

We have access to a variety of definitions and theories of this subject: religious, philosophical, biochemical, mechanical and even space physical views. Despite rationality in its own area, however, each one hardly seems to be comprehensive. Some of these go over the non-professional's head, admitting of no refutation on their essence with grand language and unintelligible jargon.

It is obvious that we have avoided scientific explanations for life due to psychological inconveniences caused by our imaginations trying to understand and challenge the mysteries of life, the reverence or expectations for life and religious, philosophical concepts.

We are at a point where life should be scientifically defined and scientific attempts are needed to uncover its phenomena. Modern science has long surpassed the functions of life. Before long, a combination of electronics, mechanics and medicine is expected to express the autonomic functions of existing organisms and there is no predicting how far biochemistry might advance and achieve organic information.

In addition, biochemical explanations for the essence of the life phenomena are hard to understand and even harder are physical and cosmological observations. Theories of cosmic energy, magnetism of energy and exchange of physical data are beyond the grasp of common people and are yet to be scientifically proven.

We are aware that individual organisms have varying degrees of mental phenomena. It is also known that the phenomena of life could never be artificially reproduced based on only biochemical, physical and functional explanations excluding mental phenomena.

Truth is always simple. Let me present a new scientific definition for the very fundamental issues comprising the phenomena of life. This would be the best truth so far that science could accept. A simple and easy explanation will be given for it to be universally understood.

I define life as “being conscious of the existence of the individual self by itself.” It might evoke questions such as “Then, what are self-motion, propagation, evolution, mind, emotion, etc.?” The answer is that they are functional aspects of existence. The essence of life is consciousness and it is the cognition of the individual being. That is thought, which can be simply defined as being aware of its own existence by itself. Let us try scientific approaches to the individual self, consciousness, existence, etc.

The Individual Self

Commonly expressed with the word “I,” the individual self is bifunctional: physical (hardware) and mental (software). Since any type of life form, an animal or a plant, has its physical realm demarcated, I feel no need to discuss it.

“I” obviously refers to an independent being, separated from other objects while “self-cognition” leads to a cognition that “I” is distinct from these others. The mental side embraces innumerable internal functions inside the distinct physical realm of “I”: thinking, emotion, mind, intelligent, etc. These functions also work in the realm of the thought of “I” which is clearly distinct from those of the other objects. “I” is the first person, an individual being distinct from other objects around him otherwise known as the second and third persons. When an individual self is established, it becomes an independent consciousness distinct from second and third persons.

Consciousness

Consciousness refers to being awake, namely cognitive thinking, reasoning and discretion. The whole of these is termed “thought.” Thought is divided into consciousness, unconsciousness and subconsciousness. Unconsciousness indicates a state in which the self-sustaining processes continue without perception. Only subconscious activities are performed. Subconsciousness refers to the inherent mental processes that are relied upon for existence. They are not perceptible in a state of consciousness.

The beginning of consciousness of existence signifies life while existence in oblivion signifies death. Life is originally a thought reflected by vasana (mental patterns) and a continuity of experience in and perception of existence through vasana.

Thought

“I think, therefore, I am.” (Rene Descartes) There are a great number of mental activities; cognition, thinking, intelligence, emotion, instinct, imagination, love, hatred, conflict, hope, despair, desire, will, belief, freedom and so forth. Emotion is categorized into joy, anger, sorrow and pleasure. It could be subdivided into a wide diversity. On close observation, each of them is the work of thought. This constitutes the core of this theory.

In this context, emotions and the mind do not exist independently or on their own. Even philosophical thoughts and religious beliefs are not independent. However, they do all belong to thought. I dare say they are under the category of thought. “I,” as a mental life, is no substance, but just thought.

What is thought, then?

Thought is no abstract concept, but an act because it exists in the frame of time whether it is perception, cognition or emotion. Anything related to time is an act that can be artificially expressed. The simplest calculation by a calculator is an act, not a concept. The built-in data or programs are conceptual, but calculation is an act since it is a process that involves time from the moment it starts.

Hence, our knowledge is that thought is an act, not a concept. Let me specify with an example: “I know that I am.” Here, “know” is no concept, but an act that is to be reproduced.

Thought creates data and accumulated data create patterns. New data made available through incessant experiences could transform the patterns (subconsciousness) or develop to evolution that would enable reproduction. It does not matter which goes first, thought or data and programs since this essay deals with the phenomena of life, not its origin.

Mental Patterns

Often we think that thought or thinking is infinite and free from control or restraint. It is erroneous. Freedom, free will and emotion are limited. Some

people are full of emotion and others are not. There are those who are endowed with thought and there are those who are not. The same applies to intelligence, imagination, artistic talent, sensitivity and so on. Any mental function is subject to limitation.

Let us discuss character and personality: a hot temper and an even temper, extroversion and introversion. It cannot be denied that these qualities are set in a mental frame, inborn or acquired. Aren't we well aware that physical limitations and mental patterns are affected by such inherent data as DNA and RNA? The programs built in subconsciousness restrain our thought.

Obviously, life cannot stay off the frame of programs formed with data and concepts (formulas) as is a computer dependent on its built-in software.

Subconsciousness is a program designated or intrinsic (given or evolved through acquisition and experience). Genes are data and vasana (patterns) just as the phenomena of life is a basic operational program referred to as subconsciousness. It is well known that every part of our body executes its specific role when we are unconscious (i.e. a sleep) and remains as active when we are awake.

Ambiguities occasionally occur. We drive a car consciously or unconsciously. While walking, we can decide which foot to put forward first or we can just keep going. Either works.

It is wondered whether consciousness and subconsciousness are inter-related or have the ability to communicate with each other during unconsciousness. If it is ever known, the correlation between fatalism and freedom will be established.

Here, we will proceed to the main subject.
“Life is aware of its existence.” This is the essence and core concept of the phenomena of life. Most of the preceding presentation was intended to answer a possible question: “Would this be all?” But it does not count for much.

In other words, the life phenomena could be reproduced if one could be artificially programmed to think of this concept on its own: “I think, therefore I am.” It is because thought embraces intelligence, emotion, cognition and such above-mentioned acts as consciousness, unconsciousness and subconsciousness. To put it in an extreme way, it would be similar to a computer being aware of its existence in continuous recognition of the functions of another computer.

Example: A toy car rolling along on its own could not be ascribed to life. However, if the car thinks, “I am rolling on, therefore I am,” it could be considered a phenomenon of life. Earlier, I proposed that “think” and “know” are merely conceptualized acts in case you might question the meanings of these words.

We must not overlook life in living organisms of lower intelligence and lacking complexity. It has not become known whether or not simple plants possess certain degrees of intelligence, thought, emotion, etc. or none at all. Even though they are considered to be devoid of free will and can only produce the intrinsic or built-in functions, no one can deny that they have life.

On the other hand, let me emphasize that my theory is not about reproducing a life identical to ours. Rather, below is a summary of this theory.
Life is a continuous cognition (thought) of one's existence.
Life is an incessant flow of consciousness of life.
Life is a continuous cognition and perception (all thought) of the individual self. It is not an abstract concept, but a continuity of perceptive acts. Acts are actual phenomena in the time frame and can be artificially reproduced.
   Here lies a well-made robot. It claims it has life.
   We ask, “What makes you think so?”
   It says, “I can see, touch, walk, sleep, laugh, be angry, calculate . . . . I am better than you in some areas. I can see clearly and feel myself. Why do you ask why?”

Now, we may have to awaken from our illusions about life. Some people could have questions about propagation, the sexes, free will, belief, etc. Let me ask. Today, mathematics and science are advanced far beyond our imagination. Self-learning artificial intelligent is near completion. The latest technologies enable a huge volume of intelligence to be reproduced or copied in a matter of milliseconds. Accurate and automatic reproduction of objects is mechanically made. A near future would see built-in data miniaturized to DNA/RNA sizes. Life and machinery would supply energy for themselves without much difficulty.

Emotions are dominantly affected by the originating situations and data. Thought has its own system. We have a long way to go before a life similar in function to a human is artificially expressed.

A coral reef in the sea has life.

It might start with simple functions or inbuilt programs and data of subconscious levels. I would not say this theory is an absolute truth. I just hope that it will be reproduced and developed to encourage serious questions about life.

### TERMS

| | | |
|---|---|---|
| Individual | A. Physical Domain | Body: A physical domain to |
| Self/“I” | (Hardware) | be recognized as “I” |
| | | Physical existences including all |
| | | types of physical function and acts |
| | | Physical domains distinct from |
| | | the objects that are not “I” |
| | B. Mental Domain | Innumerable thoughts |
| | (Software) | categorized into thinking, |
| | | emotion, mind, intelligence |
| | | Mental acts or domains |
| | | recognized as my thoughts |
| | | and distinct from other |
| | | objects such as perception |
| | | through the five senses |

| | |
|---|---|
| Consciousness | Acts of thinking that are not physical or mental |
| | substances of independent existence. Designated as |
| | “thought” and identical to “consciousness” |

We often say, “The computer knows it,” when a machine recognizes or cognizes something. Similarly it is said, “The calculator knows the answer,” or “The computer remembers it,” and the like. Obviously, machines know something that we desire.

However, we do not have a clear answer ready for the question of whether the machines know on their own as we do. A large number of studies have been offered and tried in efforts to clear up a vague hypothesis that life or consciousness should know by itself.

This theory would be justified not to dispute whether an environment for
unaided acquisition of knowledge is artificially or naturally created
because it focuses on if the machines actually know given matters on
their own.

Knowing something unaided means subjective knowledge (recognition). Subjective knowledge (recognition) is something that another subject never comes to know in a subjective way. Even though all our knowledge is subjective, it is required to be based on objectivity.

If we consider how to find out what is in other peoples' minds, we will realize that we can only base our guess on objective facts since both parties are not identical. Human limitations allow us to catch others' subjective thoughts only on an objective basis. That is because life (consciousness) is individual. Subjective facts are objectified when they meet objective requirements (evidence).

That is no contradiction in terms, but a fact. This theory should not be categorized as philosophical because it is factual.

This theory rests on two principles: the phenomena of life that we currently understand is a state of subjective consciousness in which the individual self exists and understanding of the subjective consciousness (thought) of each individual should be based on objective facts.

Even if the computer expresses perfectly its own thought that it exists, it would never be made known whether the machine is genuinely aware of it by itself or ignorant of it. This theory is not an idea nor concept, but a direct method.

### Programming Method

| Definition | Life is being conscious of the existence of the | | | |
|---|---|---|---|---|
| | individual self o [symbol] its own. | | | |
| Interpretation of | Unaided recognition (thought, consciousness) that | | | |
| the Definition | one exists. | | | |
| Recognition | I think, therefore I am. | | | |
| Method | A | B | SO | C |

(A = B, B = C, SO, A = C)

[symbol]

indicates data missing or illegible when filed

### Determination of the Physical and Mental Dominions of “I” (Individual Self)

| | |
|---|---|
| Physical | Recognition, cognition, perception of the existence of |
| Dominion | each type of physical dominion |
| | Includes conscious and unconscious physical acts for all |
| | physical existences such as vision, hearing, touch, smell |
| | taste, etc. |
| Mental | All conscious and unconscious acts of thinking for mental |
| Dominion | existences including cognition, thinking, emotion, instinct, |
| | intelligence, etc. |

Let the two dominions be acts (thoughts). If acts (thoughts) are conveyed to “B” (=think), each time they are recognized, “A” will automatically identify itself with “B” and “B” with ‘C”. Therefore (SO), the conclusion “A”=“C”.

Every time instances of “B” are recognized, the program will recognize (calculate) the conclusion “C” and express it in sounds, letters, acts, etc. as needed. (See the charts above)

To activate this process, a simple equational calculation program or any existing letter-signal decoding systems could be utilized. If needed, a new program would be easily developed. The point here is to have it calculate (think, recognize) the conclusion: “I think therefore I am.”

I. I claim the method and understanding used in recognizing the self-consciousness for all that is artificial.

II. I claim the method, which is used to define the individual self and its physical and mental domains as noted in the Terms box.

III. I claim the method, which is used to explain that Program B is continually recognizing data or program A at all times.

IV. I claim the act of defining and creation of any future programs that are developed whose purpose is to claim the individual self, life, true intelligence, or self-conscious program, and etc, which is created artificially. This is the fundamental basis of the self-conscious identification program.
